(19) United States
(12) Patent Application Publication
(10) Pub. No.: US 2015/0120843 A1
(43) Pub. Date: Apr. 30, 2015

(54) Method and Device to Store and Forward a File Thumbnail to an Initially Unavailable Client

(71) Applicant: Infinite Convergence Solutions, Inc, Arlington Heights, IL (US)

(72) Inventors: Ronald W. Cornwall, West Chicago, IL (US); Swapna A. Pidady, Streamwood, IL (US)

(73) Assignee: INFINITE CONVERGENCE SOLUTIONS, INC, Arlington Heights, IL (US)

(21) Appl. No.: 14/067,646

(22) Filed: Oct. 30, 2013

(51) Int. Cl. H04L 12/58

(52) U.S. Cl. CPC H04L 51/04
USPC 709/206

(57) ABSTRACT

A method and a telecommunications message server apparatus is presented to store and forward file thumbnails to telecommunication messaging clients which have been temporarily unavailable.

### CROSS-REFERENCE TO RELATED APPLICATIONS

None.

### FEDERALLY SPONSORED RESEARCH

None.

### SEQUENCE LISTING

None.

### FIELD OF THE INVENTION

This pertains to a telecommunications message server and method which provides file thumbnail delivery to messaging clients that are temporarily unavailable.

### BACKGROUND OF THE INVENTION

A file “thumbnail” is a small representation of a file that is used to identify a file by its contents. A file thumbnail is particularly useful in telecommunications file transfer when the file to be transferred is a photo or a video clip. A user can, for example, accept or decline the file transfer based upon what is initially seen in the file thumbnail, potentially saving time and money from an unwanted full file transfer.

The Rich Communications Suite (RCS) telecommunications standards documents provide for a file thumbnail to sometimes be used in conjunction with a file transfer. Not every client and not every carrier network supports receipt and display of a file thumbnail. Also, In a File Transfer (FT) Store and Forward (S&F) situation, where the file is stored for possible later delivery to an offline or otherwise unavailable user, the standards specifically indicate that the thumbnail “shall not include the FT thumbnail since it is not known if the recipient or recipients network has this capability.” This has the consequence of providing an inconsistent service level to the telecommunications client because under the current specification, the recipient client receives a thumbnail image when client is immediately available but the same client does not get the thumbnail if the client is not immediately available. Because of deficiencies in the delivery method and the server, the recipient client does not always get the thumbnail file they are otherwise capable of receiving. The method and device of the above inventors solve these deficiencies.

### SUMMARY OF INVENTION

This method retains a file thumbnail at a telecommunications message server stores the thumbnail and forwards the thumbnail to a telecommunications client at a later time. The recipient client could, for example, be a wireless mobile device that has recently powered up. Under the new method when the client becomes available and the server determines, by any of several methods if the messaging client is available and capable of accepting file thumbnails, the server sends the thumbnail to the recipient client. When the recipient client becomes available and it is determined the recipient client supports thumbnail service the server includes the thumbnail in the file transfer request to the recipient client. After viewing the thumbnail the recipient client can then decide to allow the associated file transfer, or not, by methods known in the art. In the preferred embodiment, where the messaging server maintains the record of which subscribers have registered, the SIP INVITE command can be used by the messaging server to deliver the thumbnail to the recipient wireless device client when it becomes available.

In networks where the registration is not received by the message server, the server can optionally initiate a SIP SUBSCRIBE to the local Presence Server to obtain the recipients capabilities. For networks without a presence server, the server can also initiate a SIP OPTIONS on behalf of the file transfer sender to obtain the recipients capabilities. This allows the message server to make an informed decision as to if the thumbnail should be included in the file transfer request. In this case the SIP OPTIONS request/response can be used between the RCS server and the recipient. A MSRP SEND command may be optionally used to transmit the associated file.

### GLOSSARY

200 OK Standard response after successful SIP request (the second step of SIP “three way handshake.”)
AS Application Server
DIAMETER A common telecommunication protocol as defined in IETF RFC 6733
FT File Transfer
HSS Home Subscriber Server
IETF Internet Engineering Task Force
IMS IP Multimedia Services
INVITE SIP Message that indicates a client is being invited to participate in a session (the first step of SIP “three way handshake”)
MDN Mobile Directory Number
MSRP Message Session Relay Protocol as defined by IETF RFC 4975
MSRP OK MSRP acknowledgement message
MSRP SEND MSRP SEND command
PNR Push Notification Request
PNA Push Notification Answer
Presence Server An entity that accepts, stores and distributes information regarding the willingness and ability of a user to communicate with other users on the network
PUBLISH A SIP command that publishes an event, such as the availability of a messaging client, to a Presence Server
RCS Rich Communication Suite
RCS-5 Rich Communication Suite version 5
RCS-e Rich Communication Suite version e, commonly used in Europe.
RCS in-a-box A network configuration where the RCS server also includes emulation of other portions of the IMS network (such as emulation of HSS)
RCS Server RCS Store and Forward Telecommunications Server
RFC A Request for Comments Document published by the Internet Engineering Task Force
SIP Session Initiation Protocol
SMPP Short Message Peer to Peer Protocol which is a telecommunications protocol typically used between message servers or a message server to a value added service provider.
S&F Store and Forward
SNA Subscriber Notification Answer
SNR Subscriber Notification Request
SUBSCRIBE a SIP Command used to request current state and state updates from a remote node
UDR User Data Request—A DIAMETER command on the Sh interface between the HSS and the AS
UDA User Data Answer Command in the DIAMETER protocol
X-CSCF Any of the I-CSCF (Interrogating—Call Session Control Function), P-CSCF (Proxy—Call Session Control Function) and S-CSCF (Serving—Call Session Control Function).

### BRIEF DESCRIPTION OF DRAWINGS

FIG. 1 shows retention and delivery of a file transfer thumbnail in a file transfer store and forward scenario where the RCS Server is receiving the registration from the recipient (either direct client registration [RCS in-a-box] or 3^{rd} party registration [RCS Server in IMS Core]).

FIG. 2 shows the retention and delivery of a file transfer thumbnail in a file transfer store and forward scenario where the message server (such as an RCS Server shown in the diagram) is informed the recipient has registered. In this case the RCS Server is not copied on the recipient's capabilities and opts to initiate a SIP OPTIONS to determine if the recipient supports Thumbnail for File Transfer.

FIG. 3 shows the retention and delivery of a file transfer thumbnail in a file transfer store and forward scenario where the RCS Server is informed the recipient has registered. In this case the RCS Server is not copied on the recipient's capabilities and opts to initiate a SIP SUBSCRIBE to the Presence Server to determine if the recipient supports Thumbnail for File Transfer. A SIP INVITE command is used to deliver the thumbnail to Client 2 in the diagram.

### DETAILED DESCRIPTION

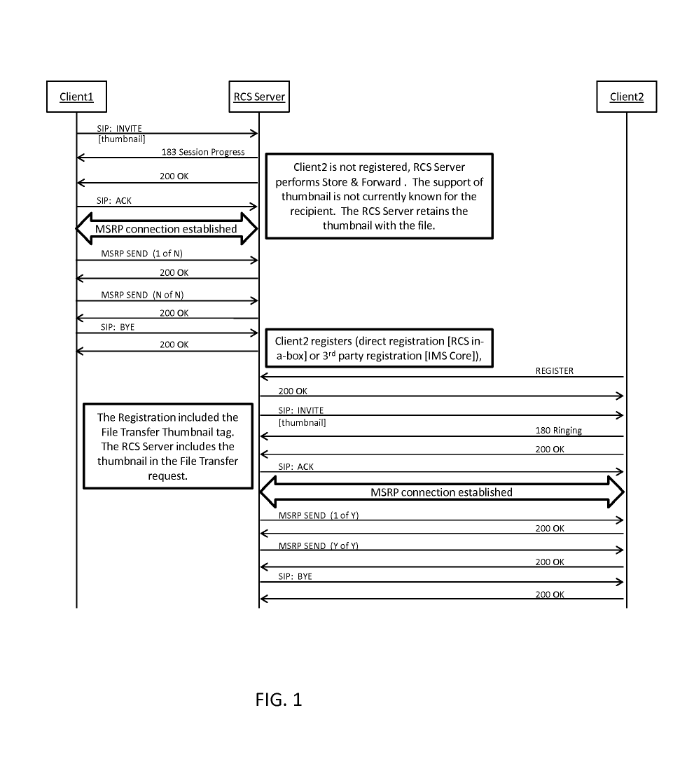

This method stores a file thumbnail at a telecommunications message server in the event the destination client device is not immediately available. In the preferred embodiment the destination client is a wireless mobile device and the Rich Communications Suite and the SIP and MSRP protocols are used to transfer the file thumbnail and associated file to and from an RCS server. The file thumbnail is retained for delivery at the server until the recipient client becomes available and the server determines, by any of several new methods, if the messaging client is available and is accepting file thumbnails. In one embodiment, as shown in FIG. 1, the registration occurs on the message server, which might know immediately from an onboard database, the thumbnail capabilities of the recipient client as well as when the client becomes available. When the recipient client becomes available and it is determined the recipient client supports thumbnail service, the server includes the thumbnail to the recipient client. The SIP INVITE command, for example, could be used to communicate the thumbnail to the recipient client. The MSRP SEND command could be repeatedly used to transmit the body of the associated file, if requested by the client.

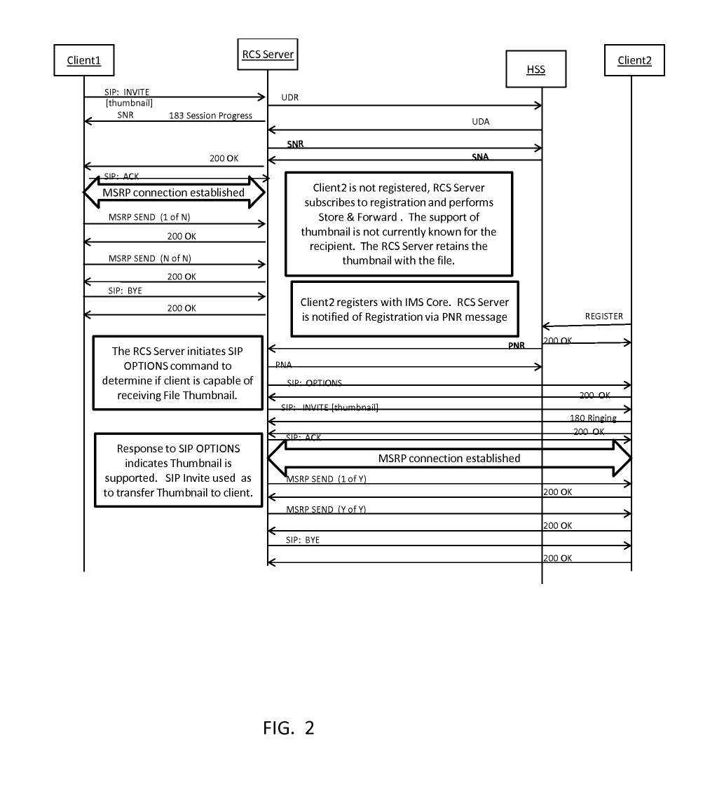

For networks without a presence server, as in FIG. 2 the message server (shown as RCS Server in the figure) can store the thumbnail with the file on the message server. The message server can initiate a SIP OPTIONS to obtain the recipients capabilities after it is notified of the client registration. This allows the message server to make an informed decision as to if the thumbnail should be included in the File Transfer request, shown as a later SIP INVITE in the diagram. Note that the SIP OPTIONS request/response is only between the message server and the recipient client (Client 2 in the diagram).

The SIP INVITE command is used to communicate the thumbnail to the recipient client, if the client supports that capability, and one or more MSRP SEND commands can optionally be used to transmit the body of the file if requested.

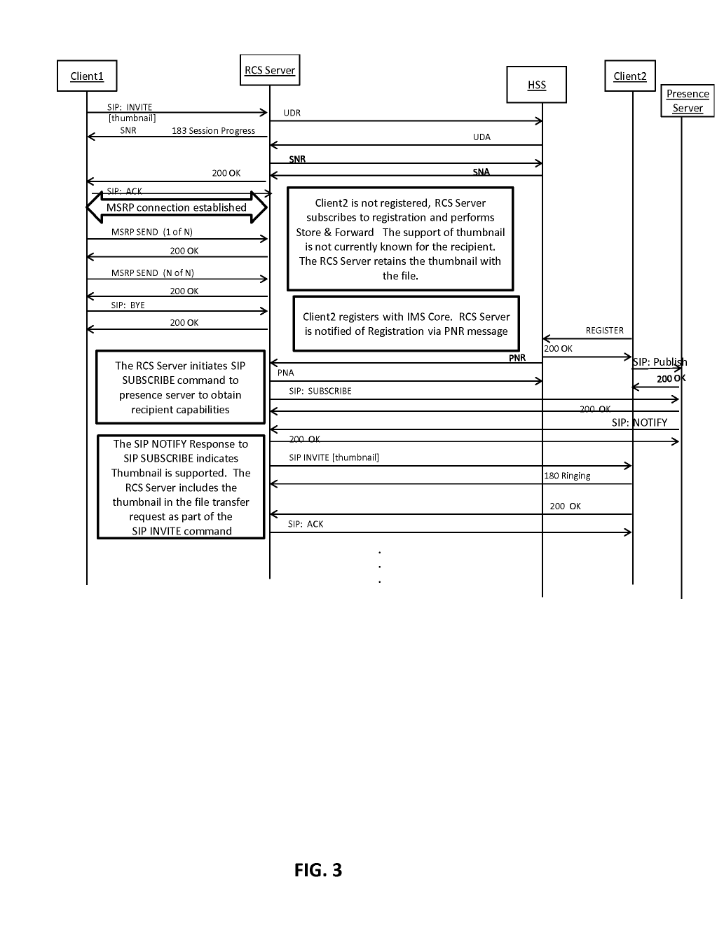

In some networks the registration is handled by the IMS Core with use of a separate Presence Server. In this case the message server stores the thumbnail with the associated file. When the message server is notified by the IMS Core of the availability of the client and based upon, for example, the message server local policy and local knowledge of the recipient, the RCS Server may initiate a SIP SUBSCRIBE to the local Presence Server to obtain the recipients capabilities as shown in FIG. 3. The Presence Server responds with a SIP NOTIFY containing the recipient's capabilities. The SIP INVITE is again used to transmit the thumbnail and one or more MSRP SEND commands can be used to transmit the file if requested by the client.

What we claim is:

1. A method to store and forward a file thumbnail to a temporarily unavailable telecommunications messaging client comprising:
a) A telecommunications message server receiving a file thumbnail;
b) the telecommunications message server determining that one or more recipient clients are unavailable;
c) the telecommunications message server storing the thumbnail for later delivery to one or more recipient clients;
d) a recipient client becoming available;
e) the message server determining if the recipient client has capabilities to receive the thumbnail;
f) if recipient client supports thumbnail receipt, the message server delivers the file thumbnail to the recipient client.

2. The method of claim 1 where a presence server is queried by the telecommunications message server to determine if the recipient client has capabilities to receive the thumbnail.

3. The method of claim 1 where the SIP SUBSCRIBE and SIP NOTIFY commands are used to obtain the recipient client thumbnail capabilities from the presence server.

4. The method of claim 1 where a SIP OPTIONS command to the recipient client is used to determine if the recipient client has capabilities to receive the thumbnail.

5. A telecommunications message server which accepts and stores a file and associated thumbnail for later delivery.

6. The telecommunications message server of claim 5 which forwards a file thumbnail to a telecommunications client after the client moves from an unavailable to an available status.

7. The telecommunications message server of claim 6 which uses a SIP INVITE to forward the file thumbnail to the client.
